(19) United States
(12) Patent Application Publication
(10) Pub. No.: US 2018/0045956 A1
(43) Pub. Date: Feb. 15, 2018

(54) HEAD UP DISPLAY APPARATUS AND DISPLAY SURFACE THEREFOR

(71) Applicant: Jaguar Land Rover Limited, Coventry, Warwickshire (GB)

(72) Inventors: Lee SKRYPCHUK, Coventry, Warwickshire (GB); Robert HARDY, Coventry, Warwickshire (GB); David AYMOND, Coventry, Warwickshire (GB)

(21) Appl. No.: 15/544,445

(22) PCT Filed: Feb. 26, 2016
(86) PCT No.: PCT/EP2016/054081

§ 371 Date: Jul. 18, 2017

(30) Foreign Application Priority Data
Feb. 27, 2015 (GB) 1503360.8

(51) Int. Cl. G02B 27/01; C03C 17/34; B60J 1/00; B60J 1/02; B60K 35/00

(52) U.S. Cl. CPC G02B 27/0101; B60J 1/02; B60K 35/00; B60J 1/001; C03C 17/3417; G02B 2027/012; G02B 2027/0194; G02B 2027/0114; B60K 2350/2052; B32B 17/10761

(57) ABSTRACT

One embodiment of the invention provides a head up display (HUD) apparatus for a vehicle, comprising a display surface, and a light source including one or more narrow band emitters for directing light towards the display surface and forming an image. At least part of the display surface is selectively more reflective at wavelengths corresponding to wavelengths of light emitted by the one or more narrow band emitters for a given angle of incidence relative to other wavelengths in the visible part of the spectrum at the same angle of incidence.

### TECHNICAL FIELD

The present disclosure relates to a head up display (HUD) apparatus and a display surface for a HUD apparatus particularly, but not exclusively, for a vehicle. Aspects of the invention relate to a HUD apparatus for a vehicle, to a display surface for use in a HUD apparatus for a vehicle, and to a vehicle including a head up display apparatus or a display surface.

### BACKGROUND

Known head up display (HUD) units usually include a projector for projecting an image and a display surface for reflecting and displaying the image. HUD units create an image that can be viewed in a vehicle operator's field of view negating the requirement for the operator to look away from the field of view in order to see the image. HUD units are increasingly common in automobiles and may be used to produce virtual images that appear to float off the vehicle's bonnet to provide information to the driver. The information may appear to be overlaid over real features of the vehicle's surroundings so as to present an augmented reality to the driver.

A problem associated with HUD units is so-called “ghosting” where multiple reflections from the display surface give rise to the formation of a double image with one image being spatially offset from the other. Ghosting arises because of the inherent thickness and transmittance of the display surface. In particular, a primary image is formed by reflections from a near surface of the display surface, and a secondary “ghost” image is formed by reflections from a far surface of the display surface following transmission through the display surface.

In automobiles where the windshield serves as the display surface, a known solution for reducing ghosting in HUD systems is to form a “wedged” vehicle windshield such that the windshield is thicker at the top than the bottom. This has the effect of manipulating the angle of reflection from the outer surface relative to the angle of reflection from the inner surface with the intent of re-aligning the primary and secondary images from the driver's viewing position. This approach is effective over a relatively small area of the windshield, but outside of this area ghosting becomes more apparent. Wedged windshields cannot therefore reduce ghosting over large areas making them less suitable for HUD applications requiring larger display areas.

It is an object of embodiments of the invention to at least mitigate one or more of the problems of the prior art.

### SUMMARY OF THE INVENTION

Aspects and embodiments of the invention relate to a head up display (HUD) apparatus for a vehicle, to a display surface for use in a HUD apparatus for a vehicle, and to a vehicle including a HUD apparatus or a display surface.

According to an aspect of the invention, there is provided a head up display (HUD) apparatus for a vehicle. The apparatus may comprise a display surface. The apparatus may comprise a light source including one or more narrow band emitters for directing light towards the display surface and forming an image. At least part of the display surface may be selectively more reflective at wavelengths corresponding to wavelengths of light emitted by the one or more narrow band emitters for a given angle of incidence relative to other wavelengths in the visible part of the spectrum at the same angle of incidence.

In certain embodiments, the display surface includes an applied coating, wherein the applied coating is selectively more reflective at wavelengths corresponding to wavelengths of light emitted by the one or more narrow band emitters relative to other wavelengths in the visible part of the spectrum. The applied coating may comprise one or more of sputter deposited material, chemical vapour deposition (CVD) deposited material, and physical vapour deposition (PVD) deposited material. In alternative embodiments, the applied coating comprises a film. The applied coating may comprise a multi-layer coating comprising layers of materials having dissimilar refractive indices relative to adjacent layers. In certain embodiments, the applied coating comprises a multi-layer coating consisting of layers of materials having dissimilar refractive indices relative to adjacent layers. The multi-layer coating may comprise alternating layers of TiO₂ and SiO₂.

In certain embodiments, at least 50% and optionally more than 75% of the display surface is selectively more reflective at wavelengths corresponding to wavelengths of light emitted by the one or more narrow band emitters relative to other wavelengths in the visible part of the spectrum. In particular embodiments, substantially all of the display surface is selectively more reflective at wavelengths corresponding to wavelengths of light emitted by the one or more narrow band emitters relative to other wavelengths in the visible part of the spectrum.

The at least part of the display surface may have a relative reflectance of at least 90% in one or more 50 nm bands that each includes wavelengths corresponding to wavelengths of light emitted by the one or more narrow band emitters for a given angle of incidence relative to wavelengths outside the 50 nm band at the same angle of incidence.

In certain embodiments, the display surface may comprise a vehicle windshield. The vehicle windshield may include a first substrate, a second substrate, and an interlayer disposed between the first substrate and the second substrate. The display surface may be disposed on an inner surface of the vehicle windshield. Alternatively, the display surface may be disposed on: a surface of the interlayer; or on a surface, of the first substrate or the second substrate, facing the interlayer.

Each of the first and second substrate may comprise glass. The interlayer may comprise a polymer, and may comprise polyvinyl butyral (PVB).

In certain embodiments, the display surface may comprise a combiner.

The one or more narrow band emitters may emit light at wavelengths within bands of 50 nm or less. The one or more narrow band emitters may emit light at wavelengths around one or more of 445 nm, 520 nm, and 635 nm. The one or more narrow band emitters may comprise one or more lasers, and the one or more lasers may include one or more of laser diodes.

In certain embodiments, the light source is arranged to emit light towards the display surface along one or more paths forming an angle of incidence between 50° and 70°. The light source may be arranged to emit light towards the display surface along one or more paths forming an angle of incidence between 58° and 62°.

According to another aspect of the present invention, there is provided a display surface for use in a head up display (HUD) apparatus for a vehicle, wherein at least part of the display surface is selectively more reflective at one or more predetermined wavelengths for a given angle of incidence relative to other wavelengths in the visible part of the spectrum at the same angle of incidence, wherein the one or more predetermined wavelengths correspond to wavelengths of light emitted by one or more narrow band emitters of the HUD apparatus.

The display surface may include an applied coating, wherein the applied coating is selectively more reflective at the one or more predetermined wavelengths for a given angle of incidence relative to other wavelengths in the visible part of the spectrum at the same angle of incidence. The applied coating may comprise one or more of sputter deposited material, chemical vapour deposition (CVD) deposited material, and physical vapour deposition (PVD) deposited material.

In certain embodiments, the applied coating comprises a film.

The applied coating may comprise a multi-layer coating comprising layers of materials having dissimilar refractive indices relative to adjacent layers. The applied coating may comprise a multi-layer coating consisting of layers of materials having dissimilar refractive indices relative to adjacent layers. The multi-layer coating may comprise alternating layers of TiO₂ and SiO₂.

In certain embodiments, at least 50% and optionally more than 75% of the display surface is selectively more reflective at the one or more predetermined wavelengths for a given angle of incidence relative to other wavelengths in the visible part of the spectrum at the same angle of incidence. In certain embodiments, substantially all of the display surface is selectively more reflective at the one or more predetermined wavelengths for a given angle of incidence relative to other wavelengths in the visible part of the spectrum at the same angle of incidence. In certain embodiments, the at least part of the display surface has a relative reflectance of at least 90% in one or more 50 nm bands that each includes wavelengths corresponding to wavelengths of light emitted by the one or more narrow band emitters for a given angle of incidence relative to wavelengths outside the 50 nm band at the same angle of incidence.

The display surface may comprise a vehicle windshield, and the vehicle windshield may include a first substrate, a second substrate, and an interlayer disposed between the first substrate and the second substrate. The display surface may be disposed on an inner surface of the vehicle windshield. Alternatively, the display surface may be disposed on: a surface of the interlayer; or on a surface, of the first substrate or the second substrate, facing the interlayer.

Each of the first and second substrate may comprise glass. The interlayer may comprise a polymer, and may comprise polyvinyl butyral (PVB).

In certain embodiments, the display surface comprises a combiner.

According to another aspect of the invention, there is provided a vehicle including the head up display apparatus described above.

According to another aspect of the invention, there is provided a vehicle including the display surface described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Certain embodiments of the invention will now be described, by way of example only, with reference to the accompanying figures, in which:

FIG. 1 shows a schematic view of a known head up display apparatus;

FIG. 2 shows a schematic view of a head up display apparatus according to an embodiment of the present invention;

FIG. 3 shows a cross sectional view of a multi-layer selective reflecting region in accordance with an embodiment of the present invention;

FIG. 4 shows a plot of the relative transmittance against wavelength for a selective reflecting region in accordance with an embodiment of the present invention; and

FIG. 5 shows a vehicle according to an embodiment of the present invention.

### DETAILED DESCRIPTION

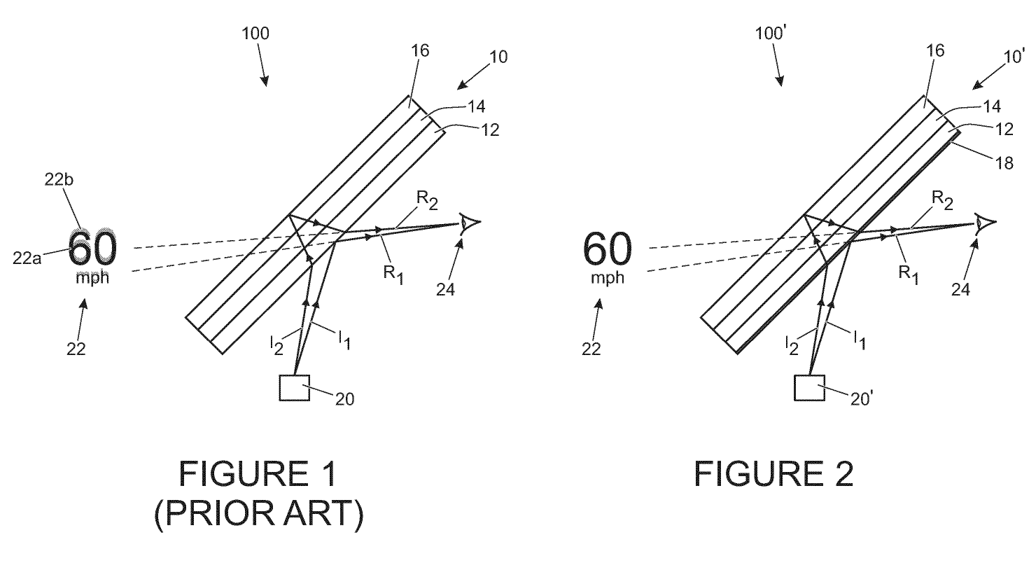

A known head up display (HUD) apparatus 100 for a vehicle is shown schematically in FIG. 1. The HUD apparatus 100 includes a light source 20 and a laminated vehicle windshield 10 made up of multiple layers forming a display surface. In particular, the windshield 10 includes an inner first substrate 12, an intermediate interlayer 14, and an outer second substrate 16. The first substrate 12 and second substrate 16 may be made of glass while the interlayer 14 may be a polymer such as polyvinyl butyral (PVB).

The light source 20 projects light towards the windshield 10 such that it is reflected towards an observer 24 (which is typically the driver of the vehicle in which the HUD apparatus 100 is installed) to form an image 22. Due to the thickness of the windshield 10, light from the light source 20 follows multiple paths before being observed by the observer 24. In particular, light from the light source 20 may follow a first incident path I₁ and be reflected from the first substrate 12 along a first reflection path R₁ towards the observer 24. Simultaneously, light from the light source 20 may follow a second incident path I₂ which is transmitted through the first substrate 12 and interlayer 14 and be reflected from the second substrate 16 so as to follow a second reflection path R₂ towards the observer 24. The predominant reflection from the second substrate 16 is by total internal reflection and occurs at the interface of the second substrate 16 and the air surrounding the second substrate 16 as opposed to the interface between the second substrate 16 and the interlayer 14. This is due to there being a greater difference in the refractive index of the second substrate 16 relative to air compared with the difference in the refractive index of the second substrate 16 relative to the interlayer 14. As a result of light being observed via multiple reflection paths, the formed image 22 includes a primary image part 22a due to the first reflection path R₁ and a secondary “ghost” image part 22b due to the second reflection path R₂.

An improved HUD apparatus 100′ according to an embodiment of the present invention is shown schematically in FIG. 2. The HUD apparatus 100′ includes a light source 20′ and a laminated vehicle windshield 10′ made up of multiple layers forming a display surface. In particular, the windshield 10′ includes an inner first substrate 12, an intermediate interlayer 14, and an outer second substrate 16. The first substrate 12 and second substrate 16 may be made of glass while the interlayer 14 may be polymer such as polyvinyl butyral (PVB). An inner surface of the windshield 10′ additionally includes a selective reflecting region 18.

The light source 20′ includes one or more narrow band emitters for producing light in one or more narrow spectral bands. The selective reflecting region 18 of the windshield 10′ is selectively more reflective at wavelengths corresponding to wavelengths of light emitted by the one or more narrow band emitters for a given angle of incidence relative to other wavelengths in the visible part of the spectrum at the same angle of incidence. The effect of matching the selective reflectivity of the selective reflecting region 18 to the emission spectrum of the light source 20′ results in increased reflection of the emitted wavelengths and broad band transmission across remaining visible wavelengths.

In use, light from the light source 20′ follows a first incident path I₁ and is reflected from the selective reflecting region 18 along a first reflection path R₁ towards an observer 24. Because the reflectivity of the selective reflecting region 18 is matched to the emission spectrum of the light source 20′ a significant proportion of incident light from first incident path ₁ is reflected along first reflection path R₁.

Whilst a significant proportion of incident light is reflected by the selective reflecting portion 18, some light (albeit a small proportion) may be transmitted therethrough. As shown in FIG. 2, light following a second incident path I₂ may be transmitted through the selective reflecting region 18, the first substrate 12, and the interlayer 14 and be reflected from the second substrate 16 along a second reflection path R₂ towards the observer 24. As described above in relation to FIG. 1, the predominant reflection from the second substrate 16 is likely to occur at the interface between the second substrate 16 and the surrounding air by total internal reflection.

Given that significantly more light is reflected than transmitted by the selective reflecting region 18 the intensity of light following the first reflection path R₁ is significantly greater than the intensity of light following the second reflection path R₂. As a result an image 22 formed by reflected light from the light source 20′ includes a much fainter ghost image part (due to significantly less light following the second reflection path R₂).

In certain embodiments, the selective reflecting region 18 and light source 20′ are selected such that any ghost image part is substantially invisible to the observer 24 under night-time and/or daylight conditions. In certain preferable embodiments, ghosting is reduced whilst transmission across wavelengths not corresponding to the emission spectrum of the light source 20′ remains high enough such that windshield transmission regulations are still satisfied.

In certain embodiments of the present invention, the one or more narrow band emitters of the light source 20′ may emit visible light substantially within one or more spectral bands having widths of 50 nm or less, 40 nm or less, 30 nm or less, 20 nm or less, 10 nm or less, or 5 nm or less. In certain embodiments of the present invention, the one or more narrow band emitters of the light source 20′ may be one or more lasers. Examples of suitable lasers include laser diodes. In certain embodiments, the one or more narrow band emitters emit at wavelengths around one or more of 445 nm, 520 nm, and 635 nm.

In alternative embodiments, the display surface of the HUD apparatus 100′ may be a combiner or any other display surface that may be positioned in the vehicle driver's (or passenger's) field of view. The display surface may be or may form part of the windshield, or the display surface may be separate to the windshield. In any embodiment, the selective reflective region 18 of the display surface may permit sufficient transmission of broad band light (i.e. outside the narrow emission bands emitted by the light source 20′) so that the display surface remains sufficiently transparent so as to not significantly inhibit viewing therethrough.

In certain embodiments the selective reflecting region 18 may be an applied coating on the display surface. In other embodiments, the selective reflecting region 18 may be formed by modifying the display surface. The selective reflecting region 18 may extend across a portion or the entire area of the display surface. For example, where the display surface is a vehicle windshield 10′, the selective reflecting region 18 may extend across at least 50% or at least 75% of an interior surface of the windshield 10′.

In embodiments, whether the selective reflecting region 18 is embodied as a coating, film or modification of the display surface, the reflecting region 18 may be disposed in one of a number of positions within the set of substrates 12, 14, 16 making up the windshield 10′. The region 18 may be applicable to any inner or outer surface of any of the substrates, and therefore may be applicable to the external air-facing surface of the windshield 10′, to an inner or internal (to the vehicle) surface as illustrated in FIG. 2, or at any intermediate position between the substrates 12, 14 and 16. At a position between substrates, for example between 12 and 14, the selective reflecting region may be applied to or formed on either of the meeting surfaces, for example the inner surface of the intermediate substrate 14, or the outer surface of the first substrate 12.

The position of the selective reflecting region 18 among the substrates may be selected in embodiments to provide the best reflectivity characteristics. For example, in comparison to the position shown in FIG. 2 on the inner surface of that first substrate 12, it may be that a position on the inner surface of intermediate substrate 14 provides good reflectivity as light from the light source has already first passed through at least one substrate (12).

In embodiments where the selective reflecting region 18 is an applied coating, the coating may be applied to the display surface by any one or more of sputtering, chemical vapour deposition (CVD), and physical vapour deposition (PVD), for example. In other embodiments, the coating may be a film that is applied to the display surface. In any embodiment in which the selective reflecting region 18 is an applied coating, the applied coating may be a multi-layer structure.

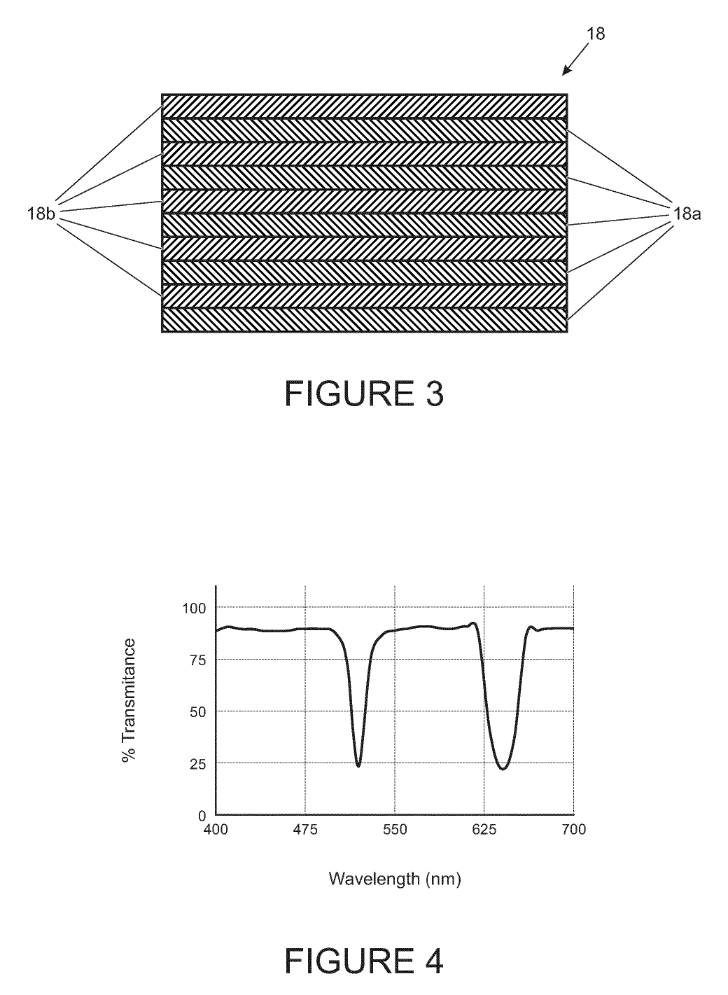

FIG. 3 shows an example of a selective reflecting region 18 in the form of a multi-layer coating. In the example of FIG. 3, the multi-layer coating is made up of alternating layers of two materials having dissimilar refractive indices relative to one another. In particular, a first material 18a with refractive index n₁ is alternately arranged with a second material 18b with a refractive index n₂, where n₁≠n₂. In one example in accordance with an embodiment of the invention, the first material 18a is TiO₂ and the second material 18b is SiO₂. In certain embodiments, the multi-layer structure may be made up of any suitable arrangement of layers, where the layers may include any number of materials having dissimilar refractive indices relative to adjacent layers. Examples of materials that may be included in the multi-layer structure include TiO₂, SiO₂, ZnS, and MgF₂.

FIG. 4 shows the wavelength dependence of relative transmittance of an example selective reflecting region 18 for an incidence angle of 60°. As shown in FIG. 4, narrow windows of decreased transmittance (i.e. increased reflectance) exist for wavelengths around 520 nm and 640 nm. The window of decreased transmittance around 520 nm is approximately 35 nm wide and the relative transmittance drops to around 23%. The window of decreased transmittance around 640 nm is approximately 40 nm wide and the relative transmittance drops to around 22%. At wavelengths outside of the windows of decreased transmittance, the relative transmittance is around 88%. Therefore, light incident on the selective reflecting region 18 is largely reflected at wavelengths falling within either of the two windows of decreased transmittance whilst light at wavelengths outside these windows is largely transmitted.

Returning to FIG. 2 and considering the selective reflecting region 18 to have a transmittance profile corresponding to FIG. 4, 77% of light emitted at 520 nm from the light source 20′ along first and second incident paths I₁ and I₂ is reflected from the selective reflecting region 18. Therefore, 77% of the light emitted along first incident path I₁ is reflected along first reflection path R₁. Additionally, 23% of light emitted along incident path I₂ is transmitted through the selective reflecting region 18. Provided that the refractive index of the interlayer 14 is similar or identical to the refractive indices of the first substrate 12 and second substrate 16, little or no reflection occurs during transmission therethrough. At the boundary between the outer surface of the second substrate 16 and the surrounding air, total internal reflection occurs and 2.1% of the 23% transmitted light (i.e. approximately 0.5% of the total incident intensity) is reflected along second reflection path R₂ towards the observer 24. This leads to a contrast ratio of 157:1 in respect of the first reflection path R₁ relative to the second reflection path R₂. As a result, any secondary ghost image part of the formed image 22 will appear 157 times less intense to the observer 24 relative to the primary image part.

To demonstrate how significant an improvement this is, in the absence of the selective reflecting region 18 (i.e. in an apparatus such as that shown in FIG. 1), the contrast ratio between the first reflection path R₁ relative to the second reflection path R₂ would be 1.21:1. As such, there would be little difference between the intensities of the primary image part 22a and the secondary ghost image part 22b.

In addition to the selective reflecting region 18 significantly improving the contrast ratio, general transmission of light outside of the narrow windows of reduced transmission is largely unaffected. The selective reflecting region 18 and any substrate that it is applied to (e.g. the windshield) are therefore not rendered significantly opaque as observed by the observer 24.

It may also be noted that an advantage of the property of the selective reflecting region 18 being highly reflective for a given angle (such as for an incidence angle of 60°) is that light in that narrow band which is not generated by the light source will generally not be reflected by the region 18, but rather transmitted. Although this may be a relatively small effect (due to the narrowness of the bands), it nevertheless means that any ambient light at those wavelengths will not decrease the contrast ratio achieved.

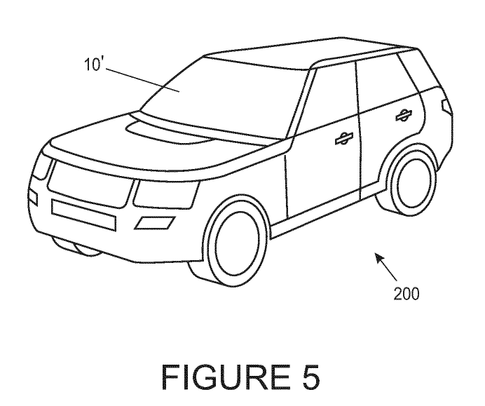

FIG. 5 shows a vehicle 200 that includes a windshield 10′ that incorporates a selective reflecting region 18 as described above in relation to FIG. 2. As noted above, the selective reflecting region 18 may cover some or all of the windshield 10′. In other embodiments, the windshield may not serve as the display surface and the selective reflecting region 18 may form part of a separate display surface that is remote from the windshield.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A head up display (HUD) apparatus for a vehicle windshield, the vehicle windshield including a first substrate a second substrate. and an interlayer disposed between the first substrate and the second substrate, the HUD apparatus comprising:
a display surface; and
a light source including one or more narrow band emitters for directing light towards the display surface and forming an image;
wherein at least part of the display surface is more reflective at wavelengths corresponding to wavelengths of Light emitted by the one or more narrow band emitters for a given angle of incidence relative to other wavelengths in the visible part of the spectrum at the same angle of incidence;,
wherein the display surface is disposed on an inner surface of the vehicle windshield; and
wherein the at least part of the display surface has a relative reflectance of at least 90% in one or more 50 nm bands that each includes wavelengths corresponding to wavelengths of light emitted by the one or more narrow band emitters for a given angle of incidence relative to wavelengths outside the 50 nm band at the same angle of incidence.

2. The HUD apparatus of claim 1, wherein the display surface comprises an applied coating, wherein the applied coating is more reflective at wavelengths corresponding to wavelengths of light emitted by the one or more narrow band emitters relative to other wavelengths in the visible part of the spectrum.

3. The HUD apparatus of claim 2, wherein the applied coating comprises one or more of sputter deposited material, chemical vapour deposition (CVD) deposited material, and physical vapour deposition (PVD) deposited material.

4. The HUD apparatus of claim 2, wherein the applied coating comprises a film.

5. The HUD apparatus of claim 2, wherein:
the applied coating comprises a multi-layer coating comprising layers of materials having dissimilar refractive indices relative to adjacent layers; or
wherein the applied coating comprises a multi-layer coating consisting of layers of materials having dissimilar refractive indices relative to adjacent layers.

6. (canceled)

7. The HUD apparatus of claim 5, wherein the multi-layer coating, comprises alternating'layers of TiO₂ and SiO₂.

8. The HUD apparatus of claim 1, wherein at least 50% and optionally more than 75% of the display surface is more reflective at wavelengths corresponding to wavelengths of light emitted by the one or more narrow band emitters relative to other wavelengths in the visible part of the spectrum.

9. The HUD apparatus of claim 8, wherein substantially all of the display surface is more reflective at wavelengths corresponding to wavelengths of light emitted by the one or more narrow band emitters relative to other wavelengths in the visible part of the spectrum.

10-13. (canceled)

14. The HUD apparatus of claim 1, wherein the display surface is disposed on:
a surface of the interlayer; or
a surface, of the first substrate or the second substrate, facing the interlayer.

15. The HUD apparatus of claim 1, wherein each of the first and second substrate comprises glass.

16. The HUD apparatus of claim 1, wherein the interlayer comprises a polymer.

17. The HUD apparatus of claim 16. wherein the interlayer comprises polyvinyl butyral (PVB).

18. The HUD apparatus of claim 1, wherein the display surface comprises a combiner.

19. The HUD apparatus of claim 1, wherein the one or more narrow band emitters emit light at wavelengths within bands of 50 nm or less.

20. The HUD apparatus of claim 19, wherein the one or more narrow band emitters emit light at wavelengths around one or more of 445 nm, 520 nm, and 635 nm.

21. The HUD apparatus of claim 19, wherein the one or more narrow band emitters comprise one or more lasers.

22. The HUD apparatus of claim 21, wherein the one or more lasers comprise one or more laser diodes.

23. The HUD apparatus of claim 1, wherein the light source is configured to emit light towards the display surface along one or more paths forming an angle of incidence between 50° and 70°.

24. The HUD apparatus of claim 23, wherein the light source is configured to emit light towards the display surface along one or more paths forming an, angle of incidence between 58° and 62°.

25-42. (canceled)

43. A vehicle including the head up display apparatus of claim 1.

44-47. (canceled)
